(19) United States
(12) Patent Application Publication
(10) Pub. No.: US 2025/0146957 A1
(43) Pub. Date: May 8, 2025

(54) DETERMINATION OF MATERIAL

(71) Applicant: Smiths Detection France S.A.S., Vitry Sur Seine (FR)

(72) Inventors: Serge MAITREJEAN, Paris (FR); Yann PERROT, Vitry-sur-Seine (FR)

(21) Appl. No.: 18/941,706

(22) Filed: Nov. 8, 2024

Related U.S. Application Data
(63) Continuation of application No. 18/469,155, filed on Sep. 18, 2023, now abandoned.
(63) Continuation of application No. 17/282,493, filed on Apr. 2, 2021, now abandoned.

(30) Foreign Application Priority Data
Oct. 5, 2018 (GB) 1816243.8

(51) Int. Cl. G01N 23/04; G01N 23/083

(52) U.S. Cl. CPC G01N 23/04; G01N 23/083; G01N 2223/04; G01N 2223/40; G01N 2223/501

(57) ABSTRACT

In an example, there is disclosed a method for determining a material in a cargo, the cargo including a first object made of a first material and a second object made of a second material. The method includes obtaining image data associated with an inspection image of the cargo, for at least two levels of radiation energy, obtaining equivalence data associated with mass equivalence of at least one of the first material and the second material with respect to a reference material, for the at least two levels of radiation energy, obtaining observation data based on the image data and the equivalence data, and determining at least one of the first material and the second material, based on the obtained observation data.

### CROSS-REFERENCE TO RELATED APPLICATIONS

This patent application is a continuation of U.S. patent application Ser. No. 18/469,155, filed Sep. 18, 2023, which is a continuation of U.S. patent application Ser. No. 17/282,493, filed Apr. 2, 2021, which is a National Stage Entry of PCT/GB2019/052745 filed on Sep. 27, 2019, which claims priority to GB Application No. 1816243.8 filed on Oct. 5, 2018, the disclosures of which are hereby incorporated by reference herein in their entirety as part of the present application.

### BACKGROUND

The disclosure relates but is not limited to a method for inspecting cargo with X-rays. The disclosure also relates but is not limited to a corresponding inspection system or apparatus and a corresponding computer product or a computer program.

Cargo inspection may use High Energy Material Discrimination (HEMD) to extract information about atomic composition of the cargo. HEMD is based on interpretation of pair creation effect and Compton scatter. The pair creation effect and the Compton scatter are indeed both material dependent (due to the effective number Z of the material and the atomic mass number) and energy dependent. Cargo inspection at two distinct energies (e.g. High Energy—HE and Low Energy—LE) may thus enable to identify cargo materials.

However material identification may be difficult for either low or large thicknesses of materials in the cargo, or when the cargo includes objects which overlap each other.

### BRIEF DESCRIPTION

Embodiments of the disclosure provide a method for determining a material in a cargo. Mass equivalence of at least some of the materials in the cargo may be obtained. The obtained mass equivalence of the materials may be expressed with respect to a reference material, and depends on radiation energy. By obtaining the mass equivalence for at least two levels of radiation energy, at least some of the materials in the cargo may be obtained.

In some examples, the obtained mass equivalence may be represented using at least one parameter associated with a difference between the mass equivalence at a higher radiation energy level and the mass equivalence at a lower radiation energy level. In some examples, the parameter may be represented as a function of the mass equivalence at the higher radiation energy level and/or as a function of an average of the mass equivalence at the higher radiation energy level and the mass equivalence at the lower radiation energy level. The representation of the parameter may enable simple approximation of materials in the cargo.

Alternatively or additionally, in some examples, at least one of the materials of the cargo may be used as a reference material for the mass equivalence, and observation data may be represented using a difference between the mass equivalence at a higher radiation energy level and the mass equivalence at a lower radiation energy level.

Embodiments of the disclosure may enable material identification even for low and/or large thicknesses of materials in the cargo, and even when the cargo includes objects which overlap each other.

Aspects and embodiments of the disclosure are set out in the appended claims. These and other aspects and embodiments of the disclosure are also described herein.

### BRIEF DESCRIPTION OF DRAWINGS

Embodiments of the present disclosure will now be described, by way of example, with reference to the accompanying drawings, in which:

FIG. 1 shows a flow chart illustrating an example method according to the disclosure;

FIG. 2 schematically illustrates an example system configured to implement, at least partly, example methods of the disclosure;

FIG. 3 shows a flow chart illustrating an example method according to the disclosure;

FIG. 4A shows graphs illustrating example differences (for three materials namely iron, aluminium and poly (methyl methacrylate) (PMMA) of the brand Plexiglas) between steel mass equivalence at high energy and steel mass equivalence at low energy, as a function of steel mass equivalence at high energy;

FIG. 4B shows graphs illustrating example differences (for several materials) between steel mass equivalence at high energy and steel mass equivalence at low energy, as a function of an average of steel mass equivalence (MEQ_{HE}+MEQ_{LE})/2;

FIG. 5A shows an example of steel mass equivalence image of a container at high energy (MEQ_{HE});

FIG. 5B shows an example of steel mass equivalence image Icorr, such that (MEQ_{HE}−MEQ_{LE});

FIG. 6A shows a flow chart illustrating an example method according to the disclosure;

FIG. 6B schematically illustrates a principle of material subtraction using MEQ graphs of FIG. 4A, where a material of Object 2 is approximated by subtracting, in two dimensions, 15 g/cm² of steel to an overlap of 30 g/cm² of PMMA of the brand Plexiglas plus 15 g/cm² of steel;

FIG. 7A schematically illustrates an example of steel mass equivalence image, such that (MEQ_{HE}−MEQ_{LE}); and

FIG. 7B shows an example of steel mass equivalence image, such that (MEQ_{HE}+MEQ_{LE})/2.

In the figures, similar elements bear identical reference numbers.

### DETAILED DESCRIPTION

### Overview

Embodiments of the disclosure provide a method for determining a material in a cargo. Mass equivalence of at least some of the materials in the cargo may be obtained. The obtained mass equivalence of the materials may be expressed with respect to a reference material, and depends on radiation energy. By obtaining the mass equivalence for at least two levels of radiation energy, at least some of the materials in the cargo may be obtained.

In some examples, the obtained mass equivalence may be represented using at least one parameter associated with a difference between the mass equivalence at a higher radiation energy level and the mass equivalence at a lower radiation energy level. In some examples, the parameter may be represented as a function of the mass equivalence at the higher radiation energy level and/or as a function of an average of the mass equivalence at the higher radiation energy level and the mass equivalence at the lower radiation energy level. The representation of the parameter may enable simple approximation of materials in the cargo.

Alternatively or additionally, in some examples, at least one of the materials of the cargo may be used as a reference material for the mass equivalence, and observation data may be represented using a difference between the mass equivalence at a higher radiation energy level and the mass equivalence at a lower radiation energy level.

Embodiments of the disclosure may enable material identification even for low and/or large thicknesses of materials in the cargo, and even when the cargo includes objects which overlap each other.

### Details Description of Example Embodiments

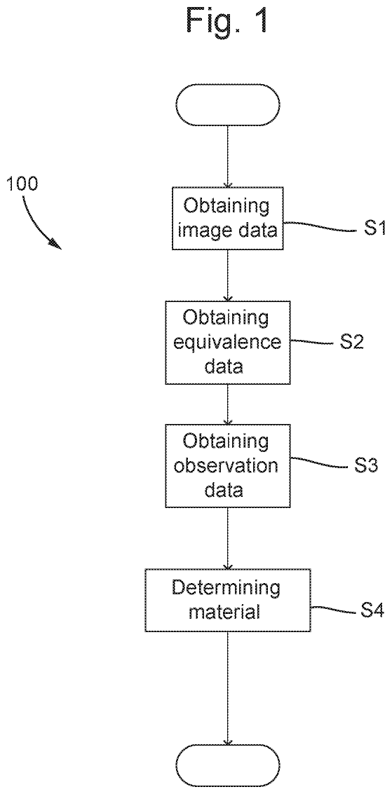

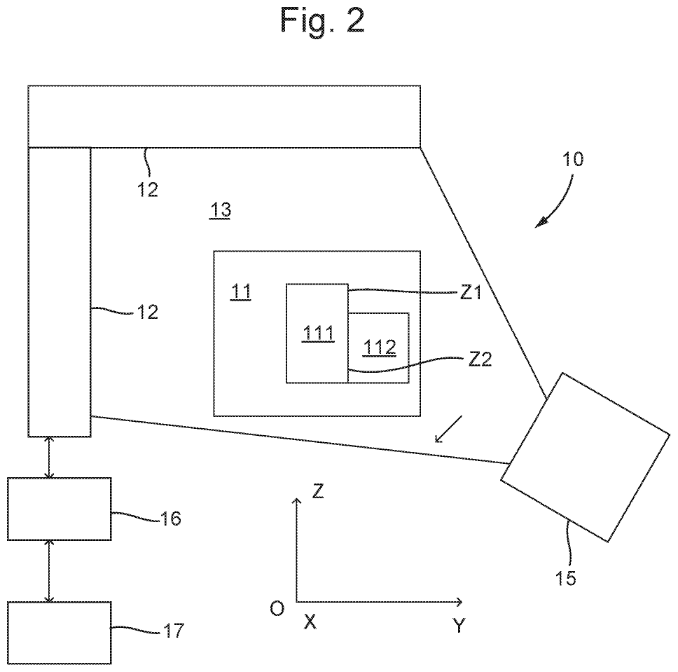

FIG. 1 shows a flow chart illustrating an example method 100 for determining a material in a cargo 11, according to the disclosure. The method 100 is illustrated in FIG. 1 in connection with FIG. 2, which shows an inspection system 10 for inspection of the cargo 11 with radiation 13 including X-rays. The system 10 may be used to perform, at least partly, the method 100 and other methods of the disclosure. In the example illustrated in FIG. 2, the system 10 includes, amongst other conventional electrical elements, a radiation detector array 12, such as an X-ray detector array including detectors configured to generate, at least partly, an inspection image of the cargo 11. The cargo 11 may include a first object 111 made of a first material and a second object 112 made of a second material.

The method of FIG. 1 mainly includes:
obtaining, at S1, image data associated with an inspection image of the cargo 11, for at least two levels of radiation energy (e.g. 6 MeV and 4 MeV, as non-limiting examples);
obtaining, at S2, equivalence data associated with mass equivalence of at least one of the first material and the second material with respect to a reference material, for the at least two levels of radiation energy;
obtaining, at S3, observation data based on the image data and the equivalence data; and
determining, at S4, at least one of the first material and the second material, based on the obtained observation data.

It should be understood that the mass equivalence of any given material (such as the first material and/or the second material, as non-limiting examples), with respect to the reference material corresponds to a thickness of an object made of the reference material, associated with a same radiation transmission, in the inspection image, as a radiation transmission associated with a thickness of an object made of the given material. For an object made of a material other than the reference material, the mass equivalence with respect to the reference material depends on radiation energy. The mass equivalence is expressed in g·cm⁻².

In some examples, the reference material may be metallic. In such examples, the mass equivalence MEQ to the reference material may be associated with metallic MEQ, such as iron MEQ, steel MEQ, lead MEQ or aluminium MEQ. In some examples, the reference material may be organic. In such examples, the mass equivalence MEQ to the reference material may be associated with organic MEQ, such as poly (methyl methacrylate) MEQ.

The radiation 13 may be generated by an X-ray source 15, which may be, in some examples, rigidly connected to the array 12. The source 15 may be moved with the array 12.

In the example illustrated in FIG. 2, the inspection system 10 may be mobile and may be transported from a location to another location (the system 10 may include an automotive vehicle). Alternatively or additionally, the inspection system may be static with respect to the ground and cannot be displaced.

As explained in further detail below in relation to FIG. 2, the inspection system 10 is configured to inspect the cargo 11. In some non-limiting examples, the inspection may be performed by transmission of inspection radiation 13 from the inspection radiation source 15 to the array 12 through the cargo 11.

In the example illustrated by FIG. 2, the system 10 may further include a controller 16, configured to communicate, via a communication network which may be wired and/or may be wireless, with the array 12 to generate, at least partly, one or more images from data received from the array 12. The controller 16 includes at least a processor and a memory in order to perform, at least partly, example methods according to the disclosure, e.g. locally on the system 10.

In the example illustrated by FIG. 2, the system 10 may further include an analyser 17 configured to receive one or more images from the controller 16, for example over a communication network which may be wired and/or may be wireless. The analyser 17 includes at least a processor and a memory in order to perform, at least partly, example methods according to the disclosure, e.g. remotely from the system 10.

In some examples, obtaining, at S1, the image data may include obtaining data associated with the inspection image of the cargo 11 from the detectors and/or from the controller 16 and/or from the analyser 17.

In some examples, obtaining, at S2, the equivalence data may include at least one of receiving the equivalence data from a calibration step and determining the equivalence data during a calibration step.

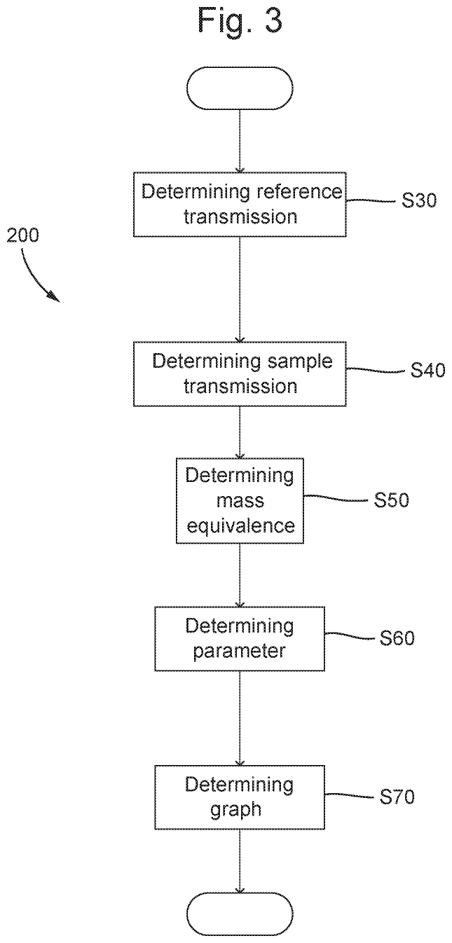

In some examples, and as illustrated in FIG. 3, determining, at method 200, the equivalence data may include:
determining, at S30 in a reference calibration sub-step, radiation transmission through a plurality of thicknesses of a reference object made of the reference material, for the at least two levels of radiation energy, detector by detector of an array of detectors configured to generate, at least partly, the inspection image of the cargo; and
determining, at S40 in at least one sample calibration sub-step, a radiation transmission through a plurality of thicknesses of at least one sample object made of a material other than the reference material, for the at least two levels of radiation energy, detector by detector of the array of detectors configured to generate, at least partly, the inspection image of the cargo; and
determining, at S50, detector by detector based on the reference calibration sub-step at S30 and the at least one sample calibration sub-step at S40, at least one of:
a mass equivalence MEQ_{HE} of the at least one a material other than the reference material to the reference material, at a higher level of radiation energy HE of the at least two levels of radiation energy, and/or
a mass equivalence MEQ_{LE} of the at least one a material other than the reference material to the reference material, at a lower level of radiation energy LE of the at least two levels of radiation energy.

In some examples, determining the radiation transmission through a plurality of thicknesses of an object includes irradiating with the radiation 13 stairs including steps of different thicknesses, e.g. of steel or any other material of interest, and detecting the transmitted radiation, detector by detector of the array 12. The determining may further involve representing the material thickness as a function of -log(transmission). Intermediate values (e.g. not corresponding to steps of the stairs) may be calculated e.g. by interpolation.

In some examples, determining the equivalence data may further include:
determining, at S60, a parameter Δ representative of a difference between the mass equivalence MEQ_{HE} to the reference material and the mass equivalence MEQ_{LE} to the reference material, such that:

Δ=MEQ_{HE}−MEQ_{LE}.

In some examples, determining the equivalence data may further include:
determining, at S70, a graph G representing the parameter Δ as a function of at least one of:
the mass equivalence MEQ_{HE} at the higher level of radiation energy; and/or
an average μ of the mass equivalence MEQ_{HE} and the mass equivalence MEQ_{LE}, such that:

$$μ = ( {MEQ}_{HE} + {MEQ}_{LE} ) / 2.$$

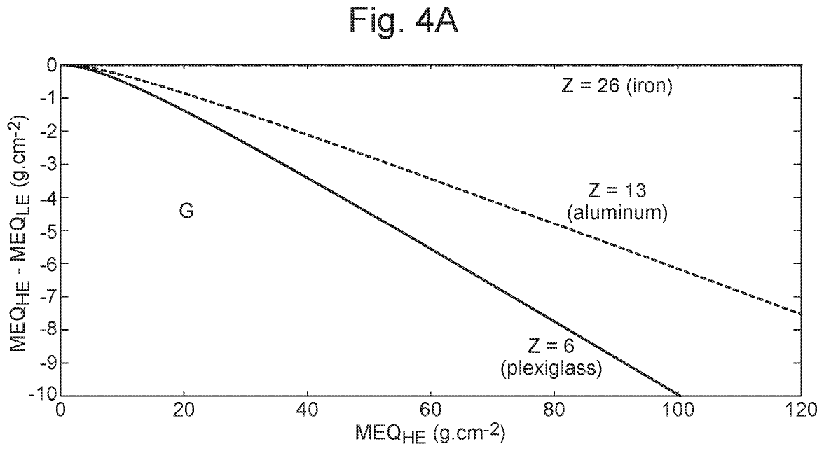

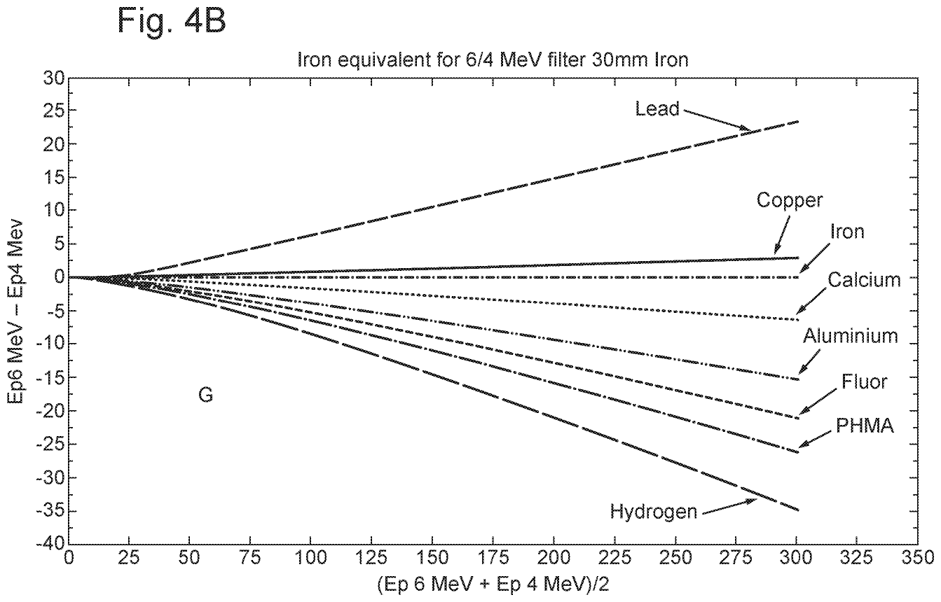

Examples of graphs G obtained during the reference calibration sub-step and/or the sample calibration sub-step are illustrated in FIGS. 4A and 4B.

As it is appreciated from FIGS. 4A and 4B, the representation of the parameter Δ with respect to the mass equivalence MEQ_{HE} (FIG. 4A) or the average μ (FIG. 4B) is nearly linear. The linear part of the graphs will be used in methods according to the disclosure, as described further down in the present disclosure.

In FIGS. 4A and 4B, the reference material is steel (or iron). The horizontal line at 0 shows that steel is the reference material. For materials with an atomic number Z lower than the atomic number of steel (such as poly (methyl methacrylate) and aluminum, as non-limiting example), Δ is smaller than 0. For materials with an atomic number Z greater than the atomic number of steel (such as lead or copper as represented in FIG. 4B), Δ is greater than 0.

Alternatively or additionally, obtaining the observation data, at S3, based on the image data and the equivalence data may include applying the obtained mass equivalence data to the reference material, to the image data.

In some examples, applying the obtained mass equivalence data to the reference material, to the image data includes:
determining, pixel by pixel of the inspection image of the cargo, based on the obtained mass equivalence data and the image data, at least one of:
a mass equivalence MEQ_{HE} of the inspection image of the cargo to the reference material, at a higher level of radiation energy HE of the at least two levels of radiation energy, and/or
a mass equivalence MEQ_{LE} of the inspection image of the cargo to the reference material, at a lower level of radiation energy LE of the at least two levels of radiation energy.

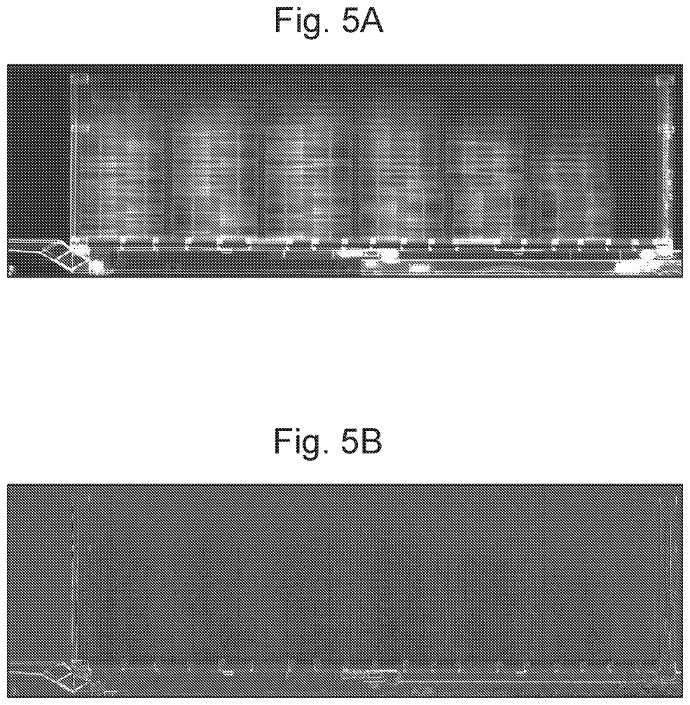

An example of an MEQ_{HE} image is illustrated in FIG. 5A. The MEQ_{HE} image could be an interesting view for operators of the system 10, e.g. in addition to the X-ray image of the cargo.

In some examples, one of the first material or the second material may be the reference material, such that the mass equivalence is expressed with respect to the first material or the second material. In such examples, determining at S4 the at least one of the first material and the second material, based on the obtained observation data, may include:

determining Icorr representative of a difference between the mass equivalence MEQ_{HE} to the reference material of the inspection image at the higher level of radiation energy and the mass equivalence MEQ_{LE} to the reference material at the lower level of radiation energy, such that:

$$Icorr = {MEQ}_{HE} - {MEQ}_{LE} .$$

An example of Icorr is illustrated in FIG. 5B.

It should be understood that steel may be removed from the image of FIG. 5A to the image of FIG. 5B. Given that the steel MEQ for steel is the same at low energy LE and high energy HE (see e.g. FIGS. 4A and 4B), most of the container wall and container roof represented in FIG. 5A disappear in an image of the difference Icorr=MEQ_{HE}−MEQ_{LE} as shown in FIG. 5B. In FIG. 5B, mostly organic materials in the cargo remain visible. The image Icorr could be an interesting view for operators, e.g. in addition to the X-ray image of the cargo.

As described below, the disclosure also enables identification of materials in one or more zones of interest where the first object overlaps the second object in the inspection image of the cargo.

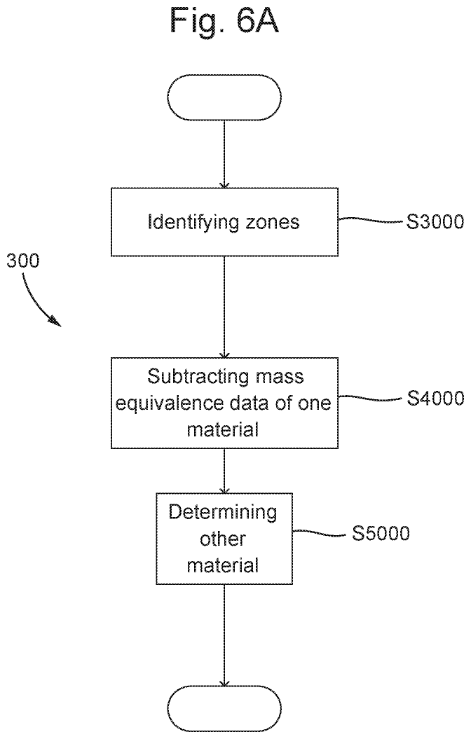

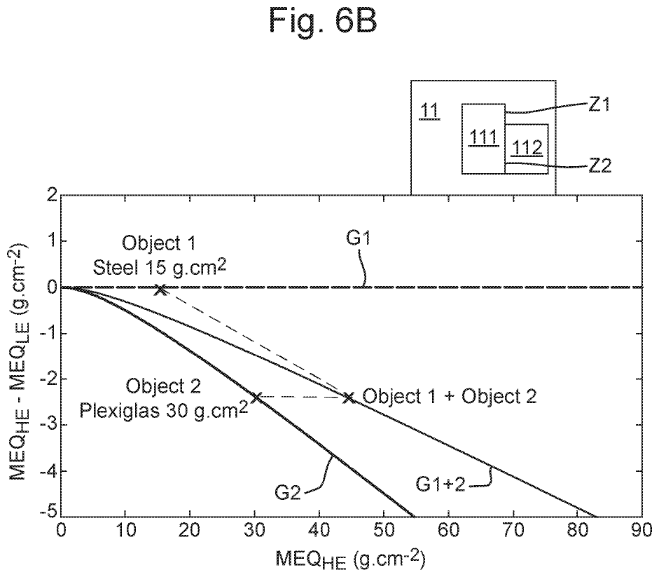

In some examples, determining at S4 the at least one of the first material and the second material, based on the obtained observation data, may include, as illustrated in FIG. 6A with reference to method 300:
identifying, at S3000, one or more zones of interest where the first object overlaps the second object in the inspection image of the cargo, and
for at least one of the identified one or more zones of interest:
subtracting, at S4000, mass equivalence data of at least one of the first material and the second material from the obtained observation data; and
determining, at S5000, the other one of the at least one of the first material and the second material, based on the subtracting.

As it is appreciated from FIGS. 4A, 4B and 6B, the representations of the parameter Δ and/or a corresponding parameter p (described in more detail below) with respect to the mass equivalence MEQ_{HE} or the average μ is nearly linear.

In some examples, subtracting at S4000 the mass equivalence data of the at least one of the first material and the second material may include:
subtracting the mass equivalence data of the first material, such that:
MEQ_{HE} for the second material=MEQ_{HE} in the identified zone−MEQ_{HE} for the first material
MEQ_{LE} for the second material=MEQ_{LE} in the identified zone−MEQ_{LE} for the first material

As illustrated in FIGS. 6A and 6B, in some examples, determining at S5000 the other one of the at least one of the first material and the second material, based on the subtracting at S4000 includes:
determining the second material from a reading on the graph G (e.g. G2 in FIG. 6B) representing the parameter Δ, using a parameter p such that:
p=MEQ_{LE} for the second material-MEQ_{HE} for the second material,
p being represented a function of at least one of:
the mass equivalence MEQ_{HE} for the second material at the higher level of radiation energy; and/or
an average μ of the mass equivalence MEQ_{HE} and the mass equivalence MEQ_{LE} for the second material, such that:

$$μ = ( {MEQ}_{HE} + {MEQ}_{LE} ) / 2.$$

As the representative graphs of the parameter Δ (e.g. graphs G1 and G2 of FIG. 6B) and/or the parameter p (e.g. graph G1+2 in FIG. 6B) are nearly linear, an overlap of objects can be approximated as an addition of MEQ, as illustrated in FIG. 6B. FIG. 6B schematically illustrates a principle of material overlap using MEQ graphs, where the overlap (as shown on graph G1+2) of the second material of the second object Object 2 (e.g. 30 g/cm² of PMMA) with the first material of the first object Object 1 (e.g. 15 g/cm² of steel) may be approximated by adding, in two dimensions, 15 g/cm² of steel (as shown on graph G1) to 30 g/cm² of PMMA (as shown on graph G2).

As a consequence, removal of overlaps may be obtained by a subtraction. FIG. 6B schematically also illustrates a principle of material subtraction using the MEQ graphs, where the second material of the second object Object 2 may be approximated (e.g. using graph G2) by subtracting, in two dimensions, 15 g/cm² of steel (graph G1) to an overlap of 30 g/cm² of PMMA with 15 g/cm² of steel (graph G1+2).

Even though the result point (Object 2 in FIG. 6B) is not exactly placed at the same position than a point corresponding to 30 g/cm² of PMMA on the graph G2 corresponding to the PMMA of the brand Plexiglas (e.g. obtained during the sample calibration sub-step described above), the two points are closed enough to provide a good estimation of the second material of the second object Object 2.

As illustrated in FIGS. 2 and 6B, in some examples, the mass equivalence data to be subtracted from the overlapping of the first material and the second material in a zone Z2 of interest may be determined based on at least one of prior knowledge (e.g. the operator of the system 10 knows that the first material is steel) and/or knowledge extracted from a zone Z1 where the first object and/or the second object do not overlap. With reference to the example illustrated in FIGS. 2 and 6B, it may be determined that the first material of the first object 111 (Object 1) is steel and that the MEQ of the first object 111 (Object 1) is 15 g/cm^{2,} based on knowledge (e.g. observation) extracted from the part Z1 of the image where the first object 111 (Object 1) does not overlap the second object 112 (Object 2). The 15 g/cm² of steel of Object 1 may then be subtracted from the zone Z2 of interest (graph G1+2 of FIG. 6B) where there is overlapping of Object 1+Object 2, to identify Object 2 as 30 g/cm² of PMMA (graph G2 of FIG. 6B), using the graphs of FIG. 6B as described above.

It should be understood that in the general case the subtracting of the equivalence data (e.g. the equivalence data of the first material in graph G1 of the example of FIG. 6B) may be done in two dimensions, i.e. along a direction of a slope of the linear part of the graph G1 corresponding to the material to be subtracted from the overlapping in graph G1+2. The subtracting in two dimensions is due to the fact that the overlapping objects may not necessarily be made of the reference material, in the general case. In other words, in the general case the first object Object 1 may not be necessarily in steel as in the specific example of FIG. 6B—the graphs of FIG. 6B being expressed with steel being the material of reference. Therefore in the general case the linear part of graph G1 corresponding to Object 1 to be subtracted may not have a slope equal to 0 as in the specific example of FIG. 6B.

A more detailed explanation of the principle for obtaining the graphs G of FIGS. 4A, 4B and 6B will now be described.

In the general case,

$${MEQ}_{HE} - {MEQ}_{LE} . = f ( Z ) \cdot g ( μ )$$

$$Or$$

$${MEQ}_{HE} - {MEQ}_{LE} . = f ( Z ) \cdot g ( {MEQ}_{HE} )$$

The function g may been chosen as a branch of hyperbola, with a nearly linear part:

$$g ( x ) = x \cdot ( ax + b ) / ( cx + d ) .$$

The parameters c and d are greater than 0, in order to avoid division by zero in our range of thicknesses. There is a degree of freedom in the values of f(Z), because it is a multiplication factor to the hyperbola, playing the same role than the ratio b/a.

With steel chosen as a reference in the examples of FIGS. 4A, 4B and 6B,

$$f ( steel ) = zero .$$

In some examples, values of f, a and b may be such that:

f(aluminum)=1.

The value of f(Z) mainly depends on the energy levels, and almost not on the detectors. Calibration may thus be simplified. For a change in energy spectrum on the system 10, recalibration during the calibration sub-steps may involve only the thicknesses of steel (i.e. the reference calibration sub-step) and not the whole set of steel, PMMA, aluminum and lead thicknesses (i.e. the sample calibration sub-step).

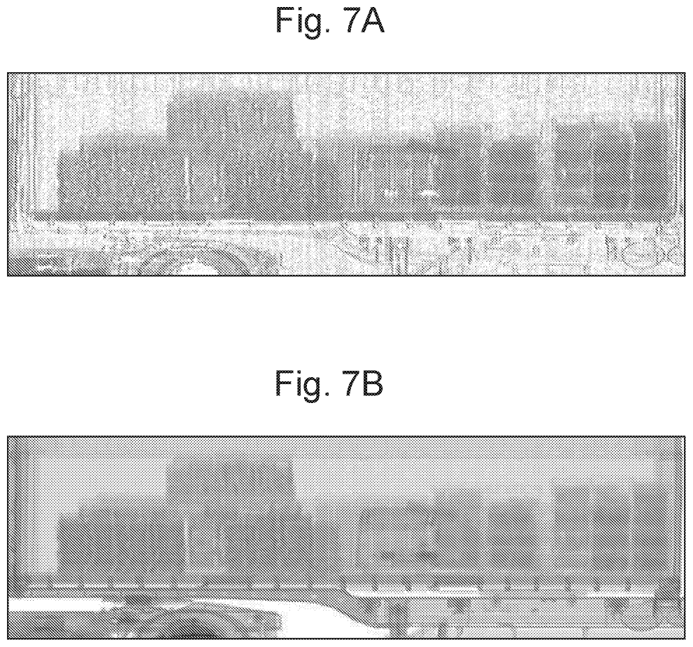

FIG. 7A illustrates image MEQHE-MEQ_{LE} and FIG. 7B illustrates image (MEQ_{HE}+MEQLE)/2.

The (MEQ_{HE}+MEQLE)/2 image could be an interesting view for operators, e.g. in addition to the X-ray image of the cargo, e.g. it is less noisy than the MEQ_{HE}−MEQ_{LE} image of FIG. 7A.

In the examples illustrated in FIG. 2, the inspection radiation source 15 may include an X-ray generator. The energy of the X-rays may be between 100 keV and 15 MeV, and the dose rate may be between 2 mGy and 20 Gy (Gray) per minute at one meter from the source. In the example illustrated by FIG. 2, the maximum X-ray energy of the X-ray source 15 may be e.g., between 100 keV and 9.0 MeV, typically e.g., 2 MeV, 3.5 MeV, 4 MeV, or 6 MeV, for a steel penetration capacity e.g., between 40 mm to 400 mm, typically e.g., 300 mm (12 in). In the example illustrated by FIG. 2, the dose may be e.g., between 20 mGy and 120 mGy. In other examples, the maximum x-ray energy of the X-ray source 15 may be e.g., between 4 MeV and 10 MeV, typically e.g., 9 MeV, for a steel penetration capacity e.g., between 300 mm to 450 mm, typically e.g., 410 mm (16.1 in). In some examples, the dose may be 17 Gy.

The system 10 may further include other types of detectors, such as optional gamma and/or neutrons detectors, e.g., adapted to detect the presence of radioactive gamma and/or neutrons emitting materials within the cargo 11, e.g., simultaneously to the X-ray inspection.

What is claimed is:

1. A method for determining a material in a cargo, the cargo comprising a first object made of a first material and a second object made of a second material, the method comprising:
obtaining image data associated with an inspection image of the cargo, for at least two levels of radiation energy;
obtaining equivalence data associated with mass equivalence of at least one of the first material and the second material with respect to a reference material, for the at least two levels of radiation energy, wherein the mass equivalence of a given material with respect to the reference material corresponds to a thickness of an object made of the reference material, associated with a same radiation transmission, in the inspection image, as a radiation transmission associated with a thickness of an object made of the given material;
obtaining observation data based on the image data and the equivalence data; and
determining at least one of the first material and the second material, based on the obtained observation data.

2. The method of claim 1, wherein, for an object made of a material other than the reference material, the mass equivalence with respect to the reference material depends on radiation energy.

3. The method of claim 1, wherein the mass equivalence is expressed in g·cm⁻².

4. The method of claim 1, wherein
the reference material being metallic, the mass equivalence MEQ to the reference material is associated with metallic MEQ, and/or
the reference material being organic, the mass equivalence MEQ to the reference material is associated with organic MEQ.

5. The method of claim 1, wherein obtaining the equivalence data comprises at least one of:
receiving the equivalence data from a calibration step; and/or
determining the equivalence data during a calibration step.

6. The method of claim 5, wherein determining the equivalence data comprises:
determining, in a reference calibration sub-step, radiation transmission through a plurality of thicknesses of a reference object made of the reference material, for the at least two levels of radiation energy, detector by detector of an array of detectors configured to generate, at least partly, the inspection image of the cargo; and
determining, in at least one sample calibration sub-step, a radiation transmission through a plurality of thicknesses of at least one sample object made of a material other than the reference material, for the at least two levels of radiation energy, detector by detector of the array of detectors configured to generate, at least partly, the inspection image of the cargo; and
determining, detector by detector based on the reference calibration sub-step and the at least one sample calibration sub-step, at least one of:
a mass equivalence MEQ_{HE} of the at least one a material other than the reference material to the reference material, at a higher level of radiation energy HE of the at least two levels of radiation energy, and/or
a mass equivalence MEQ_{LE} of the at least one a material other than the reference material to the reference material, at a lower level of radiation energy LE of the at least two levels of radiation energy.

7. The method of claim 6, wherein determining the equivalence data further comprises:
determining a parameter Δ representative of a difference between the mass equivalence MEQ_{HE} to the reference material and the mass equivalence MEQLE to the reference material, such that:
$$Δ = {MEQ}_{HE} - {MEQ}_{LE}$$
and
determining a graph G representing the parameter Δ as a function of at least one of:
the mass equivalence MEQ_{HE} at the higher level of radiation energy; and/or
an average μ of the mass equivalence MEQ_{HE} and the mass equivalence MEQ_{LE}, such that:
$$μ = ( {MEQ}_{HE} + {MEQ}_{LE} ) / 2.$$

8. The method of claim 1, wherein obtaining the observation data based on the image data and the equivalence data comprises:
applying the obtained mass equivalence data to the reference material, to the image data.

9. The method of claim 8, wherein applying comprises:
determining, pixel by pixel of the inspection image of the cargo, based on the obtained mass equivalence data and the image data, at least one of:
a mass equivalence MEQ_{HE} of the inspection image of the cargo to the reference material, at a higher level of radiation energy HE of the at least two levels of radiation energy, and/or
a mass equivalence MEQ_{LE} of the inspection image of the cargo to the reference material, at a lower level of radiation energy LE of the at least two levels of radiation energy.

10. The method of claim 9, wherein one of the first material or the second material is the reference material, and
wherein determining the at least one of the first material and the second material, based on the obtained observation data, comprises:
determining Icorr representative of a difference between the mass equivalence MEQ_{HE} to the reference material of the inspection image at the higher level of radiation energy and the mass equivalence MEQ_{LE} to the reference material at the lower level of radiation energy, such that:
$$Icorr = {MEQ}_{HE} - {MEQ}_{LE} .$$

11. The method of claim 9, wherein determining the at least one of the first material and the second material, based on the obtained observation data, comprises:
identifying one or more zones of interest where the first object overlaps the second object in the inspection image of the cargo, and
wherein determining the at least one of the first material and the second material, based on the obtained observation data, comprises, for at least one of the identified one or more zones of interest:
subtracting mass equivalence data of at least one of the first material and the second material from the obtained observation data; and
determining the other one of the at least one of the first material and the second material, based on the subtracting.

12. The method of claim 11, wherein subtracting the mass equivalence data of the at least one of the first material and the second material comprises:
subtracting the mass equivalence data of the first material, such that:
MEQ_{HE} for the second material=MEQ_{HE} in the identified zone−MEQ_{HE} for the first material; and
MEQ_{LE} for the second material=MEQ_{LE} in the identified zone−MEQ_{LE} for the first material.

13. The method of claim 11, wherein the mass equivalence data to be subtracted from the overlapping of the first material and the second material in a zone of interest is determined based on at least one of:
prior knowledge; and/or
knowledge extracted from a zone where the first object and/or the second object do not overlap.

14. An apparatus comprising:
at least a processor; and
a memory,
wherein the memory comprises instructions which, when executed by the processor, enable the processor to perform the method according to claim 1.

15. A non-transitory computer readable medium containing instructions, that when executed by a processor, enable the processor to perform a method according to claim 1.

16. The apparatus of claim 14, wherein, for an object made of a material other than the reference material, the mass equivalence with respect to the reference material depends on radiation energy.

17. The apparatus of claim 14, wherein the mass equivalence is expressed in g·cm⁻².

18. The method of claim 2, wherein the mass equivalence is expressed in g·cm⁻².

19. The method of claim 1, wherein
the reference material being metallic, the mass equivalence MEQ to the reference material is associated with metallic MEQ, and/or
the reference material being organic, the mass equivalence MEQ to the reference material is associated with organic MEQ.
